(19) United States
(12) Patent Application Publication
(10) Pub. No.: US 2007/0263232 A1
(43) Pub. Date: Nov. 15, 2007

(54) Image forming system

(76) Inventors: Hirofumi Nakajima, Tokyo (JP); Eiji Sugimoto, Tokyo (JP)

Correspondence Address: CANTOR COLBURN, LLP, 55 GRIFFIN ROAD SOUTH, BLOOMFIELD, CT, 06002, US

(21) Appl. No.: 11/714,452

(22) Filed: Mar. 6, 2007

(30) Foreign Application Priority Data
May 11, 2006 (JP) JP2006-132332

(51) Int. Cl. G06F 1/00

(52) U.S. Cl. 358/1.1

(57) ABSTRACT

To provide an image forming system composed of an image forming apparatus having a plurality of connected post-processing apparatuses wherein the plurality of post-processing apparatuses can be used independently and the image forming apparatus has a control device for permitting independent use of a post-processing apparatus connected with and on the downstream side of the post-processing apparatus being used for the job in execution.

This application is based on Japanese Patent Application No. 2006-132332 filed on May 11, 2006 in Japanese Patent Office, the entire content of which is hereby incorporated by reference.

### BACKGROUND OF THE INVENTION

The present invention relates to control for an image forming apparatus connected with a plurality of post-processing apparatuses.

To respond to demand of speedup and multi-function of the image forming work, an image forming system composed of a high-speed image forming apparatus having a plurality of connected post-processing apparatuses is generally used.

The post-processing apparatus referred to here is a publicly known apparatus for performing processes such as perforating, shifting, binding, and bookbinding to sheets outputted after image formation by the image forming apparatus.

In such a system, sheets outputted from the image forming apparatus are sent to a post-processing apparatus designated according to a set job, are subject to predetermined post processing, and are sequentially loaded on a designated sheet ejection tray.

In an actual office, various jobs are executed by the aforementioned image forming system, and jobs in which sheets which are not subject to the post processing, sheets processed by one post-processing apparatus, and sheets processed by a plurality of post-processing apparatuses coexist. Furthermore, there is a job carried out by supplying not only sheets outputted from the image forming apparatus but also other sheets to the post-processing apparatus connected to the image forming apparatus, to perform only post processing.

Generally, jobs executed by the aforementioned image forming system mostly do not use all the apparatuses connected to the system but use a part of the post-processing apparatuses. Under such circumstances, when set jobs are executed simply according to the setting order, some apparatuses among the image forming system become in a nonuse state, thus a problem of lowering the operation rate of the apparatuses arises. Further, a user may not be satisfied with a fact that when some of the post-processing apparatuses are operated, the other apparatuses of the system cannot be used.

To respond to such a problem, there is a proposal of enabling a job of performing only post processing for sheets by installing a sheet supply section on the post-processing apparatus so as to supply sheets from both the image forming apparatus and the sheet supply section, and by using independently the post-processing apparatus, (for example, refer to Patent Document 1). Further, there is another proposal of enabling manual use of the post-processing apparatus and of permitting the image forming system to execute only a process independent of the post processing during manual execution of the post processing (for example, refer to Patent Document 2).

However, in an image forming system having a plurality of connected post-processing apparatuses, conveying paths for sheets used for the processing of independently use of the post-processing apparatuses (referred to as off-line processing) and conveying paths for sheets used for the processing of executing the post processing to sheets outputted from the image forming apparatus according to an instruction of a set job (referred to as job processing) have many common parts. Therefore, there are cases where the post-processing apparatuses cannot be used on off-line in order to ensure the conveying path for ejecting sheets and cases in which when there is a post-processing apparatus executing off-line processing, even the job processing which does not use the concerned post-processing apparatus cannot be executed.

Patent Document 1: Unexamined Japanese Patent Application Publication No. 2003-89469

Patent Document 2: Unexamined Japanese Patent Application Publication No. 2005-250271

### SUMMARY

The present invention was developed in view of the foregoing and it is intended to provide an image forming system composed of an image forming apparatus having a plurality of connected post-processing apparatuses for executing both post processing performed for sheets outputted from the image forming apparatus and post processing conducted by using a post-processing apparatus which is not being used for the aforementioned post processing in parallel with each other.

The aforementioned problem can be accomplished by the following embodiments.

One of the aspects is an image forming system composed of an image forming apparatus having a plurality of connected post-processing apparatuses characterized in that the plurality of post-processing apparatuses can be used independently and the image forming apparatus has a control device for permitting use of a post-processing apparatus connected on the downstream side of the post-processing apparatus used by the job in execution.

One of the aspects is an image forming system composed of an image forming apparatus having a plurality of connected post-processing apparatuses characterized in that the plurality of post-processing apparatuses can be used independently and the image forming apparatus, when there is a post-processing apparatus in use, has a control device for receiving a job executable by apparatuses on the upstream side of the post-processing apparatus in use.

### BRIEF DESCRIPTION OF THE DRAWINGS

FIG. 1 is a conceptual diagram of the image forming system.

FIG. 2 is a conceptual diagram of the image forming apparatus.

FIG. 3 is a block diagram showing the control relationship of the image forming system.

FIG. 4 is a conceptual diagram of the first to third post-processing apparatuses.

FIG. 5 is a flow chart showing the flow of the job receiving process.

### DETAILED DESCRIPTION OF THE PREFERRED EMBODIMENT

An embodiment of the present invention will be explained as follows, referring to the drawings.

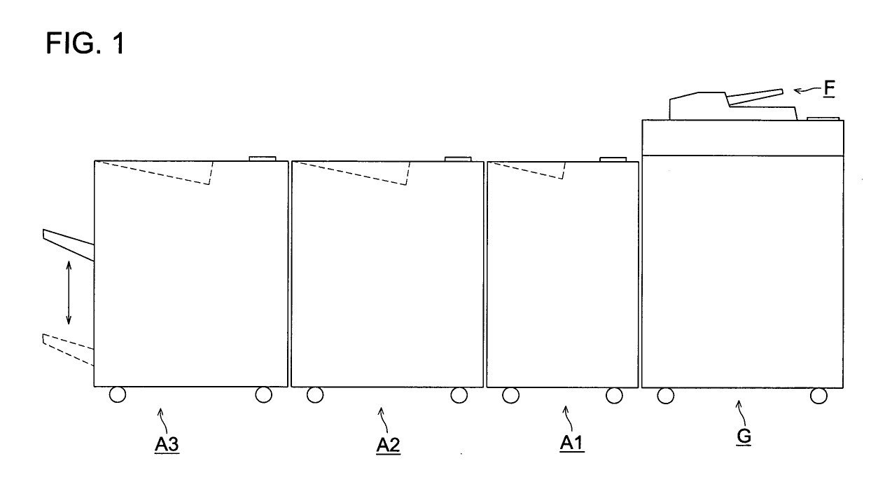

FIG. 1 is a schematic diagram of image forming system in which an image forming apparatus is connected with a plurality of post-processing apparatuses. The image forming system shown in FIG. 1 is constituted of image forming apparatus G, first post-processing apparatus A1, second post-processing apparatus A2 and third post-processing apparatus A3.

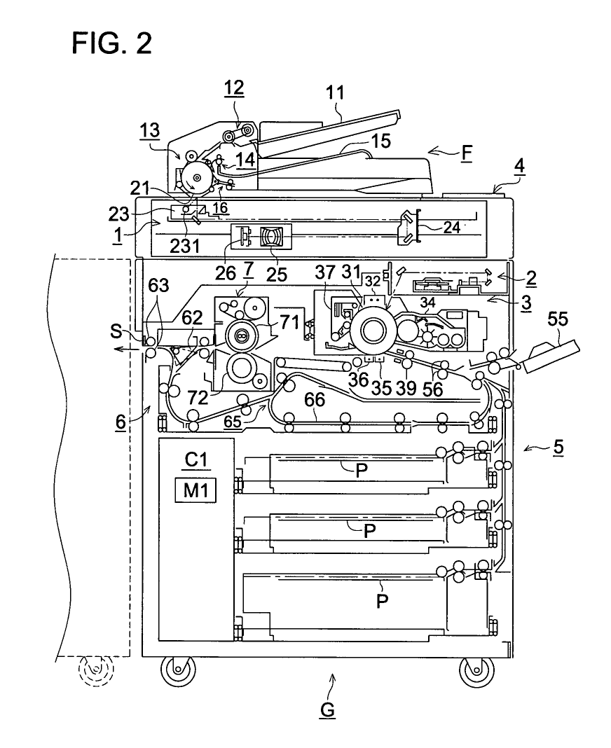

FIG. 2 is a schematic diagram of image forming apparatus G.

The image forming apparatus G has, at the upper portion of its main body, automatic document feeder F, and the main body is composed of image reading device 1, image writing device 2, image forming device 3, operation/display device 4, sheet feeding device 5, ejection and re-feeding device 6, fixing device 7 and control device C1 and others.

The automatic document feeder F feeds out the documents placed on document tray 11 to document conveyance device 13 individually with document separating device 12, and the document conveyance device 13 conveys the document sent thereto to document ejection device 14, and then the document ejection device 14 conveys the document sent thereto to document ejection tray 15. An image on the document is read through slit 21 representing a document image reading position on the image reading device 1 provided on a document conveyance path.

When images on both sides of the document are read, the document whose first side has been read is reversed from side to side by document reversing device 16 having a pair of rollers to be sent out to the document conveyance device 13 again so that the second side may be read. The document whose both sides have been read is ejected to the document ejection tray 15.

The image reading device 1 is a device to read a document image and thereby to obtain image data, and a document image illuminated by lamp 231 is formed as an image on image sensor 26 representing a linear CCD (Charge Coupled Device) at the position of slit 21, by the first mirror unit 23, the second mirror unit 24 and by image formation lens 25. Signals outputted from the image sensor 26 are subjected to A/D conversion in an image processing section of control device C1, and are stored in memory M1 as image data after being subjected to processes of shading correction and image compression or others.

In image writing device 2, based on image data called from memory M1 and subjected to prescribed image processing, a circumferential surface of rotating image carrier 31 whose surface is charged evenly by charging device 32 is scanned optically with a laser beam and a polygon mirror, whereby, an electrostatic latent image corresponding to the document image is formed on the circumferential surface of the image carrier 31.

The electrostatic latent image is subjected to reversal development by developing device 34 of image forming device 3, and a toner image is formed on the image carrier 31.

Sheet P is fed from manual feeding device 55 or from sheet feeding device 5 having a cassette and a tray housing recording sheets P as a transfer material, to be conveyed by conveyance roller 56, corresponding to a timing of toner image forming, and synchronization in terms of a position between the aforesaid toner image formed on the image carrier and the sheet is carried out by timing rollers 39, and then, the sheet is sent out to a transfer area.

In the transfer area, the toner image formed on the surface of the image carrier 31 is transferred onto the sheet P that is charged electrically to be in opposite polarity by transfer device 35.

The sheet P carrying the toner image is separated from the surface of the image carrier 31 by actions of separation and discharge device 36, and is sent to fixing device 7.

In the fixing device 7, the sheet P carrying the toner image is conveyed while it is heated and pressed respectively by heat roller 71 and pressure roller 72, thus, the toner image is fixed on the sheet P and then sent out to the first post-processing apparatus A1 with ejection roller 63.

When sending the sheet P to the first post-processing apparatus A1 after reversing it from side to side, the sheet P is led to ejection and re-feeding device 6 by switching guide 62 so that the sheet P switchbacks to be sent to the ejection roller 63.

When forming images on both sides of the sheet P, the sheet P which has been subjected to fixing on its first surface is led to the ejection and re-feeding device 6 by the switching guide 62, and it is fed out to conveyance path 66 for sheet feeding after being reversed by reversing section 65, to be ready for image forming on the second surface.

On the other hand, the surface of the image carrier 31 from which the toner image has been transferred onto the sheet P is cleaned by cleaning device 37 so that residual toner may be removed to be ready for succeeding image forming.

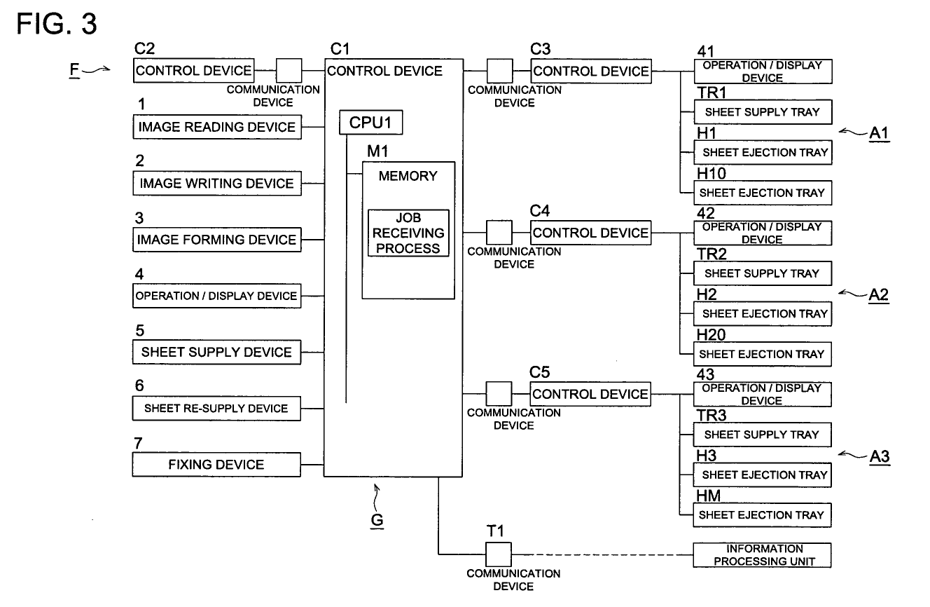

FIG. 3 is a block diagram showing control relations of image forming system. Control device C1 is a computer system having CPU (CPU1), memory M1, an operation unit which is not illustrated, I/O port, interface for communication and circuits for driving respective devices. Control for each device is carried out by executing programs corresponding to the job, stored in the memory M1.

A control device C2 of an automatic document feeder 1, a control device C3 of a first post-processing apparatus A1, a control device C4 of a second post-processing apparatus A2, and a control device C5 of a third post-processing apparatus A3 have a smaller scale than that of a control device C1, however they have a similar system constitution including CPUs. Information exchange between the control device C1 and the other control devices is executed via a communication device in this example.

Further, the control device C1 is connected to the LAN or public line via a communication device T1, thereby can exchange data between itself and other information units.

Further, the blocks which are not directly relating to the explanation of the embodiment of the present invention are omitted in the drawings.

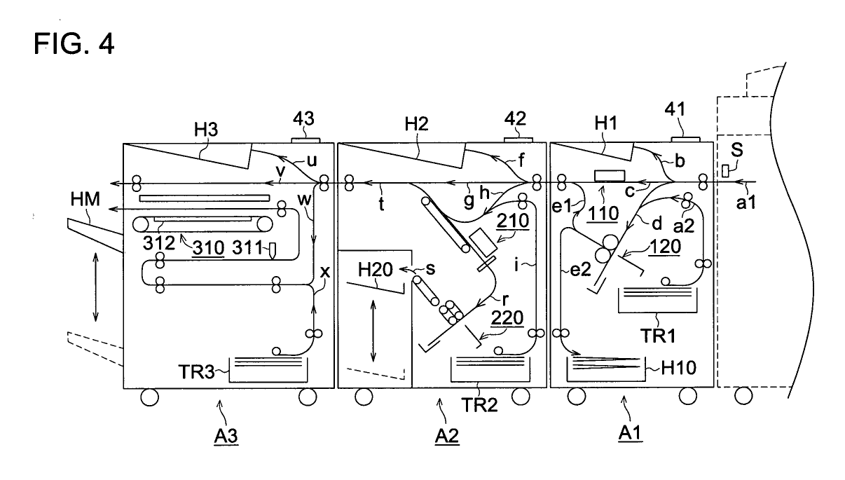

FIG. 4 is a schematic diagram of the first to third post-processing apparatuses A1, A2, and A3 connected to an image forming apparatus G.

The first post-processing apparatus A1 is a post-processing apparatus having an operation/display device 41, a perforating device 110, and a center-folding device 120 and is composed of the known art. A sheet P sent from the image forming apparatus G and entering the first post-processing apparatus A1 in the direction of an arrow “a1”, according to a job (job processing) preset on the operation/display device 4 of the image forming apparatus G by a user or according to a job (off-line processing) set on the operation/display device 41 of the post-processing apparatus A1 by a user, moves forward on any route of the three routes indicated by “b”, “c”, and “d” shown in the drawing.

The route “b” is a route for leading the sheet P to a sheet ejection tray H1 without post-processing it.

The route “c” is a route when making a hole at the end of the sheet P by the perforating device 110 and sending it to the second post-processing apparatus A2 or when sending straight the sheet P to the second post-processing apparatus A2 without post-processing it.

The route “d” is a route for performing the center-folding process for sheets P one by one or every plurality of sheets by the center-folding device 120. The sheets P are sent thereto from the image forming apparatus G or sent from a sheet supply tray TR1 through a route “a2” and the sheets P subject to the center-folding process are sent to the second post-processing apparatus A2 via a route “e1” or to a sheet ejection tray H10 via a route “e2”.

By use of this constitution, when the job for performing the post process for the sheets P sent from the image forming apparatus G is not set, the post-processing apparatus A1, while ejecting the sheets P sent from the image forming apparatus G to the sheet ejection tray H1, according to the job set on the operation/display device 41, sends the sheets P loaded on the sheet supply tray TR1 to the center-folding device 120, and stores the sheets P subject to the center-folding process in the sheet ejection tray H10 via the route “e2” or sends the sheets P to the post-processing apparatus A2 via the route “e1”. The above off-line processing can be performed.

The second post-processing apparatus A2 is a post-processing apparatus having an operation/display device 42, a stapler 210, and a center-folding device 220 and is composed of the known art. For the sheets P sent from the first post-processing apparatus A1, according to a job (job processing) preset on the operation/display device 4 of the image forming apparatus G by a user or according to a job (off-line processing) set on the operation/display device 42 of the post-processing apparatus A2 by a user, any of the three routes indicated by “f”, “g”, and “h” shown in the drawing is selected.

The route “f” is a route for leading the sheet P to a sheet ejection tray H2 without post-processing it by the second post-processing apparatus A2.

The route “g” is a route for leading the sheet P to the third post-processing apparatus A3 without post-processing it by the second post-processing apparatus A2.

Sheet P led through the route “h” or sent from a sheet supply tray TR2 through a route “i” passes through a route to the stapler 210 and the stapler 210 stacks a plurality of sheets P, forms a sheet bundle, and performs the binding process at an end or on the centerline of the sheet bundle with staples. The sheet bundle subject to the binding process on the centerline moves forward on the route indicated by an arrow “r”, and is subject to the center-folding process by the center-folding device 220, and then is ejected to a sheet ejection tray H20 via a route “s”. The sheet bundle subject to the binding process at an end is sent to the route indicated by an arrow “t” and moves toward the third post-processing apparatus A3.

By use of such a constitution, when the job to be subject to the post-processing by the post-processing apparatus A2 or A3 is not set, the post-processing apparatus A2, while ejecting the sheets P sent from the post-processing apparatus A1 to the sheet ejection tray H2, according to the job set on the operation/display device 42, sends the sheets P loaded on the sheet supply tray TR2 to the stapler 210 and stores the sheets P subject to the binding process and center-folding process in the sheet ejection tray H20 via the route “s” or sends the sheets P with the ends thereof bound to the post-processing apparatus A3 via a route “t”. The above off-line processing can be performed.

The third post-processing apparatus A3 is a post-processing apparatus including an operation/display device 43, a bookbinding device 310 for performing the binding process using paste, and a large capacity sheet ejection tray HM and is composed of the known art.

For the sheets P sent from the second post-processing apparatus A2, according to a job (job processing) preset on the operation/display device 4 of the image forming apparatus G by a user, any of the three routes indicated by “u”, “v”, and “w” shown in the drawing is selected.

The route “u” is a route for leading the sheet P to a sheet ejection tray H3 without post-processing it by the third post-processing apparatus A3.

The route “v” is a route for leading the sheet P to the sheet ejection tray HM without post-processing it by the third post-processing apparatus A3.

The route “w”, and a route “x” for leading the sheets P sent from a sheet supply tray TR3 due to execution of a job (off-line processing) set on the operation/display device 43 are routes for performing the bookbinding process for the sheets P. The bookbinding device 310 shown in this embodiment performs a binding process by coating hot melt type paste at the ends of the sheets P by a coating device 311, loading the sheets P of a predetermined number on a loading table 312, and pressurizing and heating the ends. For the art adopted as a bookbinding device, arts other than the one shown in this embodiment can be selected properly.

By use of such a constitution, when the job for performing the post processing by the post-processing apparatus A3 is not set for the sheets P sent from the image forming apparatus G is not set, the post-processing apparatus A3, while ejecting the sheets P sent from the post-processing apparatus A2 to the sheet ejection tray H3, according to the job set on the operation/display device 43, sends the sheets P, which were loaded on the sheet supply tray TR3 and fed via the route “x”, to the bookbinding device 310 and the off-line processing of storing the sheets P subject to the bookbinding process on the sheet ejection tray HM can be performed.

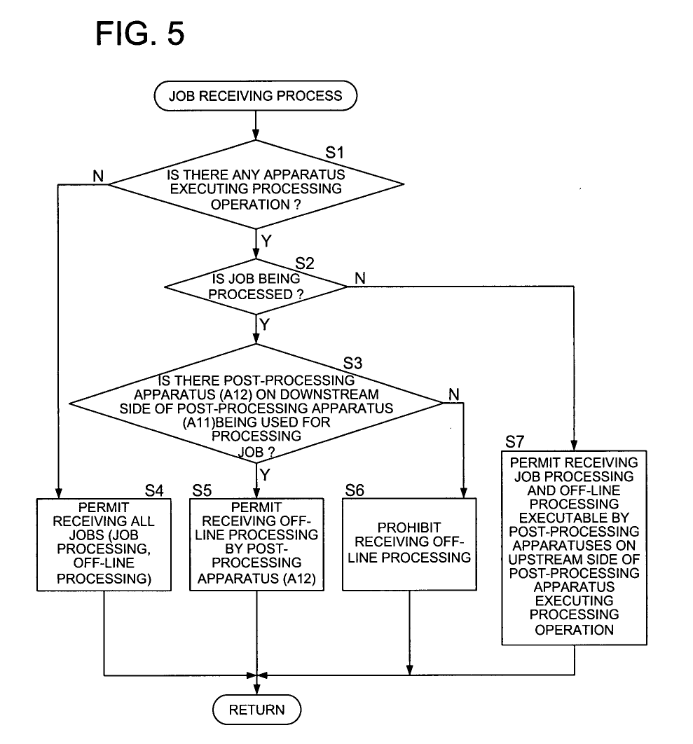

FIG. 5 is a flow chart showing the flow of the job receiving process of the image forming system mentioned above.

When all the apparatuses of the image forming system are in the standby state, that is, when there are no apparatuses executing the processing operation (N at Step S1), receiving of the jobs of all the kinds is permitted (Step S4). The jobs of all the kinds mentioned above mean the jobs for executing the aforementioned job processing and off-line processing.

If any apparatus of the image forming system is in the operating state (Y at Step S1) and the processing (job processing) executed by the image forming apparatus G and post-processing apparatus is not performed, that is, if the off-line processing is performed by any post-processing apparatus (N at Step S2), only the job processing or off-line processing is received (Step S7), which can be executed by apparatuses which are on the upstream side of the post-processing apparatus being executing the processing operation.

Further, if any apparatus of the image forming system is in the operating state (Y at Step S1) and the processing (job processing) executed by the image forming apparatus G and post-processing apparatus is performed (Y at Step S2), whether the post-processing apparatus (referred to as A12) which is not used by the job processing exists or not, on the downstream side of the post-processing apparatus (referred to as A11) which is being used for the job processing is determined (Step S3). When it exists (Y at Step S3), only the job of the off-line processing executable by the post-processing apparatus (A12) which is not used for the job processing is received (Step S5).

Further, when the post-processing apparatus (A12) which is not used for the job processing does not exist on the downstream side of the post-processing apparatus (A11) which are being used for the job processing (N at Step S3), receiving of the job performing the off-line processing is all prohibited (Step S5).

The job receiving process of the image forming system as explained above is performed, thus the post-processing apparatus independent of execution of the job is used effectively and the operation rate of the apparatus is improved. Further, an inconvenience of simultaneously trying to use one post-processing apparatus for a plurality of jobs can be avoided.

Further, the type and number of a plurality of post-processing apparatuses to be connected are determined when the image forming system is structured and are not limited to this embodiment.

According to the image forming system of the present invention, improvement of the operability of the image forming system composed of an image forming apparatus having a plurality of connected post-processing apparatuses and improvement of the operation rate of the apparatus are realized.

What is claimed is:

1. An image forming system comprising:
an image forming apparatus including a control device; and
a plurality of post-processing apparatuses which are connected in a line with the image forming apparatus and which can be used independently,
wherein the control device controls so that both a first apparatus group including the image forming apparatus and one or a plurality of post-processing apparatuses among the plurality of post-processing apparatuses and a second apparatus group including one or a plurality of post-processing apparatuses among the plurality of post-processing apparatuses can be used independently, the second apparatus group being on a downstream side of the first apparatus group.

2. The image forming system of claim 1,
wherein the control device allows independent use of the second apparatus group when the first apparatus group is used for a job in execution.

3. The image forming system of claim 1,
wherein when there are one or a plurality of post-processing apparatuses in use among the plurality of post-processing apparatuses, the control device accepts a job which can be conducted by using other one or a plurality of post-processing apparatuses among the plurality of post-processing apparatuses, the other one or a plurality of post-processing apparatuses being on an upstream side of a most upstream post-processing apparatus among the one or plurality of post-processing apparatuses in use.

4. The image forming system of claim 1,
wherein each of the plurality of post-processing apparatuses has a sheet ejection tray for storing a sheet processed in apparatuses connected on an upstream side of the each of the plurality of post-processing apparatuses.

5. The image forming system of claim 1,
wherein each of the plurality of post-processing apparatuses has a sheet supply tray for storing a sheet to be processed in the each of the plurality of post-processing apparatuses or in one or a plurality of post-processing apparatuses connected on a downstream side of the each of the plurality of post-processing apparatuses.

6. The image forming system of claim 1,
wherein each of the plurality of post-processing apparatuses has a control device for independently controlling the each of the plurality of post-processing apparatuses.

7. The image forming system of claim 1,
wherein each of the plurality of post-processing apparatuses has an operation/display device for independently controlling the each of the plurality of post-processing apparatuses.

8. The image forming system of claim 1,
wherein each of the plurality of post-processing apparatuses has a sheet ejection tray for storing a sheet processed in the each of the plurality of post-processing apparatuses.

9. The image forming system of claim 1,
wherein each of the plurality of post-processing apparatuses has a route for ejecting, without processing, a sheet which has come from one or a plurality of post-processing apparatuses connected on an upstream side of the each of the plurality of post-processing apparatuses, a route for sending the sheet to a post-processing apparatus connected on a downstream side of the each of the plurality of post-processing apparatuses without processing, and a route for sending the sheet for processing conducted in the each of the plurality of post-processing apparatuses.

10. The image forming system of claim 1,
wherein each of the plurality of post-processing apparatuses has a route for processing of a sheet conducted in the each of the plurality of post-processing apparatuses, the sheet being from a sheet supply tray in the each of the plurality of post-processing apparatuses, and for sending the sheet to a post-processing apparatus connected on a downstream side of the each of the plurality of post-processing apparatuses.

11. The image forming system of claim 1,
wherein the control device of the image forming apparatus and a control device of other information processing unit communicate information through a communication device.

12. The image forming system of claim 1,
wherein the control device of the image forming apparatus and a control device of each of the plurality of post-processing apparatuses communicate information through a communication device.

13. The image forming system of claim 1,
wherein the first apparatus group conducts a job processing and the second apparatus group conducts an off-line processing.
